(19) United States
(12) Patent Application Publication
(10) Pub. No.: US 2003/0114182 A1
(43) Pub. Date: Jun. 19, 2003

(54) Adaptive power amplifier

(76) Inventors: Paul L. Chan, Encinitas, CA (US); Jonathan Klaren, San Diego, CA (US); Charles J. Persico, Rancho Sante Fe, CA (US); Scott Walter, San Diego, CA (US)

Correspondence Address: Sarah Kirkpatrick, Manager, Intellectual Property Administration, QUALCOMM Incorporated, 5775 Morehouse Drive, San Diego, CA, 92121-1714, US

(21) Appl. No.: 10/051,792

(22) Filed: Jan. 16, 2002

Related U.S. Application Data
(60) Provisional application No. 60/343,287, filed on Dec. 19, 2001.

(51) Int. Cl. H04B 7/00

(52) U.S. Cl. 455/525; 455/67.1; 455/343; 455/127

(57) ABSTRACT

Power detectors sense load mismatch conditions and cause the power output of a power amplifier to be reduced in response to a load mismatch. Transmitted and reflected power measurements are used to calculate a load mismatch criterion. A power amplifier is configured based on the calculated load mismatch criterion. A dual-directional coupler may be used to separate a power signal into transmitted and reflected components. With output power reduced under load mismatch conditions, signal distortion levels may be reduced to acceptable levels.

### RELATED APPLICATIONS

This application claims priority to pending Provisional application No. 60,343,287, filed on Dec. 19, 2001, which is incoproated herein by reference.

### FIELD

Various embodiments relate to radio frequency (RF) power amplifiers and, more particularly, to RF power amplifiers for wireless communication devices (WCDs).

### BACKGROUND

Wireless communication systems are widely deployed to provide various types of communication, such as voice and data communications. These systems may be based on a variety of modulation techniques, such as frequency division multiple access (FDMA), time division multiple access (TDMA), and various spread spectrum techniques. One common spread spectrum technique used in wireless communications is code division multiple access (CDMA) signal modulation. In a CDMA system, multiple communications are simultaneously transmitted over a spread spectrum radio frequency (RF) signal. Some example wireless communication devices (WCDs) that have incorporated CDMA technology include cellular radiotelephones, PCMCIA cards incorporated within portable computers, personal digital assistants (PDAs) equipped with wireless communication capabilities, and the like. A CDMA system provides certain advantages over other types of systems, including increased system capacity and quality of service.

Other wireless communication systems may use different modulation techniques. For example, GSM systems use a combination of TDMA and FDMA modulation techniques. These techniques are also used in other systems related to GSM systems, including the DCS1800 and PCS 1900 systems, which operate at 1.8 GHz and 1.9 GHz, respectively.

Regardless of the communication system used to transmit voice and data communications, a transmitter within a WCD incorporates a power amplifier to output voice and data signals via an antenna. To promote transmission efficiency, this power amplifier is typically optimized for the anticipated load. When the power amplifier is presented with a load that differs from the anticipated load, a significant portion of the power output by the power amplifier is reflected back to the amplifier and is not transmitted. As a result, the effective radiated power may be significantly reduced. In addition, the transmitted signal may be distorted, particularly as output power increases.

To prevent adverse effects associated with load mismatches, some WCDs incorporate circulators or isolators that present a fixed load to the power amplifier. Circulators and isolators pass power in one direction, but not in the reverse direction, and are therefore commonly used to protect the output of equipment from reflected signals. Some other WCDs incorporate a balance amplifier to present a fixed load to the power amplifier.

### SUMMARY

One embodiment is directed to a method for configuring a power amplifier associated with a wireless transmitter in response to a load mismatch condition. A load mismatch criterion relative to the wireless transmitter is evaluated. The power amplifier is configured as a function of the load mismatch criterion. In some implementations, a dual-directional coupler separates a power signal into transmitted and reflected components, which are then detected, for example, using a broadband power detector. In another embodiment, transmitted and reflected power signal levels are received and used to configure a gain of the power amplifier.

Various embodiments may be implemented in software, hardware, firmware, or any combination thereof. If implemented in software, a computer readable medium may carry program code, that when executed, performs one or more of the methods mentioned above.

An example hardware embodiment is wireless communication device that includes a power amplifier and a control arrangement to configure the power amplifier as a function of a load mismatch criterion. The apparatus may also include a dual-directional coupler to separate a power signal into a transmitted power signal component and a reflected power signal component and power detectors to generate transmitted and reflected power signal levels that are received by the control arrangement and used to configure the power amplifier.

Additional details of various embodiments are set forth in the accompanying drawings and the description below. Other features, objects, and advantages will become apparent from the description and drawings, and from the claims.

### BRIEF DESCRIPTION OF THE DRAWINGS

FIG. 1 is a block diagram illustrating a wireless communication system.

FIG. 2 is a block diagram depicting an example implementation of a WCD.

FIG. 3 is a block diagram illustrating an example adaptive power amplifier.

FIG. 4 is a block diagram illustrating another example adaptive power amplifier.

FIG. 5 is a flow diagram illustrating an example mode of operation of a WCD.

### DETAILED DESCRIPTION

In general, signal distortion may be reduced by detection of load mismatch conditions and reduction of the power output by a power amplifier in response to a load mismatch. More particularly, various embodiments detect transmitted and reflected power and determine a load mismatch condition based on the transmitted and reflected power measurements. In some implementations, a dual-directional coupler is used to separate a power signal into transmitted (forward) and reflected (reverse) components.

As a result, output power may be reduced under load mismatch conditions, thereby reducing signal distortion levels to acceptable levels. If the mismatch exceeds a threshold, the power amplifier may be shut down to avoid wasting battery power, thereby prolonging battery charge life. In addition, power amplifiers may be operated without the use of an isolator or circulator while maintaining linear amplification of a transmitted signal.

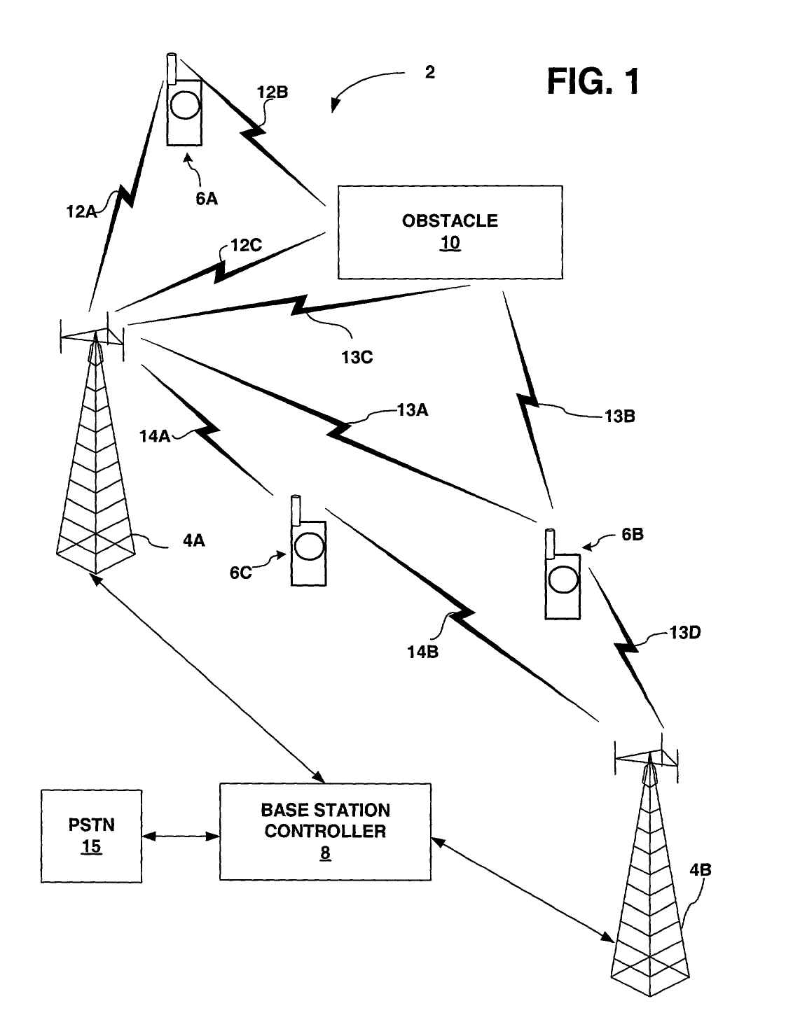

FIG. 1 is a block diagram illustrating an example spread spectrum wireless communication system 2, in which base stations 4 transmit signals 12, 13, 14 to WCDs 6 via one or more paths. In particular, base station 4A transmits signal 12A to WCD 6A via a first path, as well as signal 12C, via a second path caused by reflection of signal 12B from obstacle 10. Obstacle 10 may be any structure proximate to WCD 6A such as a building, bridge, car, or even a person.

Base station 4A also transmits signal 13A to WCD 6B via a first path from base station 4A, as well as signal 13C via a second path caused by reflection of signal 13B from obstacle 10. In addition, base station 4A transmits signal 14A to WCD 6C. WCDs 6 may implement what is referred to as a RAKE receiver to simultaneously track the different signals received from different base stations and/or from the same base station but via different paths. System 2 may include any number of WCDs 6 and base stations 4. For example, as illustrated, another base station 4B receives signal 13D from WCD 6B. In addition, base station 4B receives signal 14B from WCD 6C.

System 2 may be designed to support one or more CDMA standards including, for example, (1) the “TIA/EIA-95-B Mobile Station-Base Station Compatibility Standard for Dual-Mode Wideband Spread Spectrum Cellular System” (the IS-95 standard), (2) the “TIA/EIA-98-C Recommended Minimum Standard for Dual-Mode Wideband Spread Spectrum Cellular Mobile Station” (the IS-98 standard), (3) the standard offered by a consortium named “3rd Generation Partnership Project” (3GPP) and embodied in a set of documents including Document Nos. 3G TS 25.211, 3G TS 25.212, 3G TS 25.213, and 3G TS 25.214 (the W-CDMA standard), (4) the standard offered by a consortium named “3rd Generation Partnership Project 2” (3GPP2) and embodied in a set of documents including “TR-45.5 Physical Layer Standard for cdma2000 Spread Spectrum Systems,” the “C.S0005-A Upper Layer (Layer 3) Signaling Standard for cdma2000 Spread Spectrum Systems,” and the “C.S0024 CDMA2000 High Rate Packet Data Air Interface Specification” (the CDMA2000 standard), (5) the HDR system documented in TIA/EIA-IS-856, “CDMA2000 High Rate Packet Data Air Interface Specification, and (6) some other standards. In addition, system 2 may be designed to support other standards, such as the GSM standard or related standards, e.g., the DCS 1800 and PCS 1900 standards. GSM systems employ a combination of FDMA and TDMA modulation techniques. System 2 may also support other FDMA and TDMA standards.

WCDs 6 may be implemented as any of a variety of wireless communication devices, such as, for example, a cellular radiotelephone, a satellite radiotelephone, a PCMCIA card incorporated within a portable computer, a personal digital assistant (PDA) equipped with wireless communication capabilities, and the like. Base stations 4 (sometimes referred to as base transceiver systems, or BTSS) are typically connected to a base station controller (BSC) 8 to provide an interface between base stations 4 and a public switched telephone network (PSTN) 15.

To transmit voice and data communications, WCDs 6 transmit radio frequency (RF) signals generated in response to user input, e.g., via a keypad or microphone. Baseband processing circuitry conditions this user input to generate baseband signals, which are upconverted, filtered, and amplified. The upconverted and amplified RF signal is transmitted to base station 4 via an antenna that is typically also used to receive RF signals. In accordance with some implementations, one or more of WCDs 6 may incorporate a power amplifier that detects load mismatch conditions and adjusts power output accordingly. For example, in some embodiments, the power amplifier measures transmitted and reflected power signal levels.

Under good load match conditions, e.g., when the load presented to the amplifier is similar to the anticipated load, most of the power output by the power amplifier is transmitted rather than reflected. As a result, the transmitted power signal level is high compared to the reflected power signal level. With low levels of signal distortion, the power amplifier may be permitted to transmit at full power.

When the load presented to the amplifier differs significantly from the anticipated load, however, considerable amounts of power may be reflected back toward the power amplifier. The reflected power signal level may therefore be relatively high, and may even exceed the transmitted power signal level. Under these conditions, power is wasted, and significant levels of signal distortion may be present. Accordingly, to conserve power and reduce signal distortion, the power output of the amplifier is reduced under load mismatch conditions. In addition, if the mismatch exceeds a prescribed threshold, the power amplifier may be shut off.

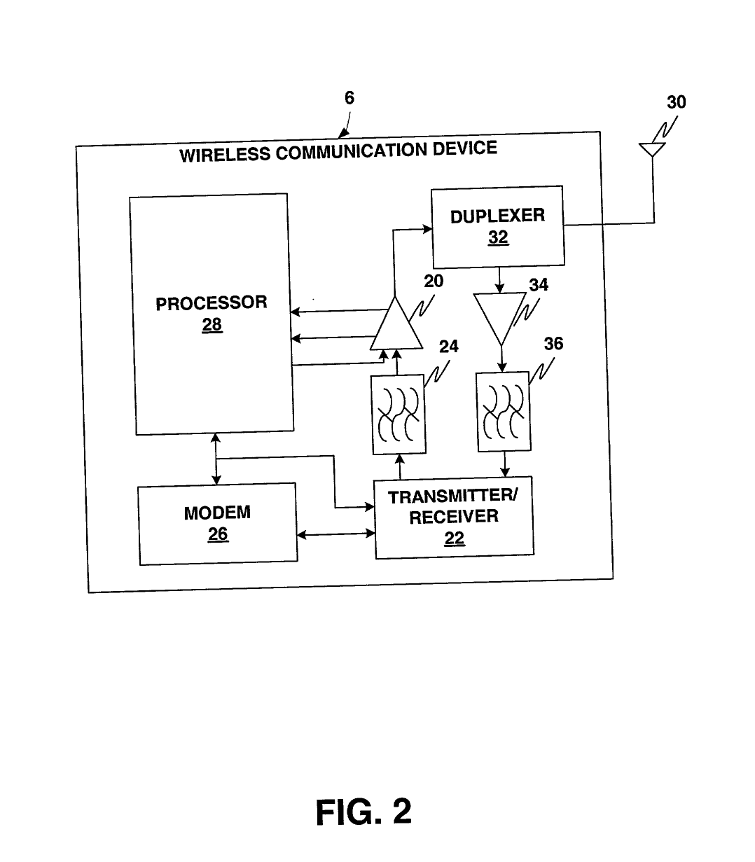

FIG. 2 is a block diagram illustrating an example wireless communication device (WCD) 6 having a power amplifier module 20 with a power output that is adjustable in response to load mismatch conditions as described above in connection with FIG. 1. WCD 6 may be designed to support one or more CDMA standards and/or designs, such as the W-CDMA standard, the IS-95 standard, the cdma2000 standard, and the HDR specification. WCD 6 may also support other standards, such as the GSM standard, and may therefore be configured to transmit TDMA or FDMA signals, or both.

As shown in FIG. 2, WCD 6 may include, in addition to power amplifier module 20, a radio frequency (RF) transmitter/receiver 22, a transmit bandpass filter 24, a modem 26, a microprocessor 28, a radio frequency antenna 30, a duplexer 32, a low noise amplifier (LNA) 34, and a receive bandpass filter 36. In addition, WCD 6 may include other circuitry that is not depicted in FIG. 2, such as channel searching hardware.

Modem 26 includes demodulator/decoder circuitry and modulator/encoder circuitry, both of which are coupled to transmitter/receiver 22 to transmit and receive the communication signals. To transmit communication signals, modem 26 modulates voice or data input according to a modulation scheme. The modulation scheme may involve CDMA, TDMA, or FDMA. In some systems, the modulation scheme may involve a combination of CDMA, TDMA, and FDMA modulation techniques. The modulated signal is then provided to transmitter/receiver 22, which generates a RF output signal. Transmit bandpass filter 24 filters the RF output signal and provides the filtered signal to power amplifier module 20.

Power amplifier module 20 amplifies the filtered signal and outputs the amplified signal to the transmit path of duplexer 32 and antenna 30, which present a load impedance to power amplifier module 20. When the load impedance presented by antenna 30 and duplexer 32 is similar to the anticipated load impedance for which power amplifier module 20 is optimized, power amplifier module 20 is matched to antenna 30 and duplexer 32. Under these conditions, most of the power output by power amplifier module 20 is actually transmitted to antenna 30. A relatively small amount of power may be lost through heat dissipation or reflection. By contrast, when the load impedance presented by antenna 30 and duplexer 32 differs significantly from the anticipated load impedance, power amplifier module 20 is mismatched to antenna 30 and duplexer 32. Such load variation may be caused by any of a number of conditions, such as placement of WCD 6 on a metal surface. When power amplifier module 20 is mismatched to antenna 30 and duplexer 32, part of the power output by power amplifier module 20 is reflected back along the transmission line between power amplifier module 20 and antenna 30 and duplexer 32 toward power amplifier module 20 and is wasted. Accordingly, for a desired power output by antenna 30, the power output by power amplifier module 20 must be increased. For example, if only 25% of the power output by power amplifier module 20 is actually transmitted by antenna 30, then power amplifier module 20 must output 4 Watts (W) to transmit 1 W via antenna 30. Power amplifiers typically exhibit non-linear characteristics with increased output power, causing signal distortion.

With part of the power output by power amplifier 20 reflected back toward power amplifier module 20, the power signal present on the transmission line between power amplifier module 20 and antenna 30 and duplexer 32 contains both transmitted and reflected power signal components. According to some embodiments, these transmitted and reflected power signal components may be compared with each other to determine the degree of load mismatch, i.e., the degree to which the load presented by antenna 30 and duplexer 32 differs from the anticipated load for which power amplifier module 20 is optimized.

To reduce signal distortion to an acceptable level under load mismatch conditions, power amplifier module 20 detects the transmitted and reflected power signal levels and provides these signal levels to microprocessor 28. Based on the transmitted and reflected power signal levels, microprocessor 28 determines a load mismatch criterion. For example, microprocessor 28 may calculate the ratio of the reflected power signal level to the transmitted power signal level, or may calculate the ratio of the reflected power signal level to the overall (transmitted and reflected) power signal level. In some embodiments, microprocessor 28 may calculate the load impedance and compare the load impedance to an optimal impedance, e.g., the anticipated load impedance for which power amplifier module 20 is optimized. If antenna 30 and duplexer 32 are mismatched to power amplifier module 20, microprocessor 28 outputs a gain control signal to power amplifier module 20 to reduce the gain of power amplifier module 20. Accordingly, the power output by power amplifier module 20 is reduced, thereby reducing signal distortion. While not required, microprocessor 28 may temporarily disable power amplifier module 20 if antenna 30 and duplexer 32 are sufficiently mismatched to power amplifier module 20, e.g., if the load mismatch criterion exceeds some prescribed threshold. Microprocessor 28 may subsequently reactivate power amplifier module 20 to determine whether the load mismatch condition still exists.

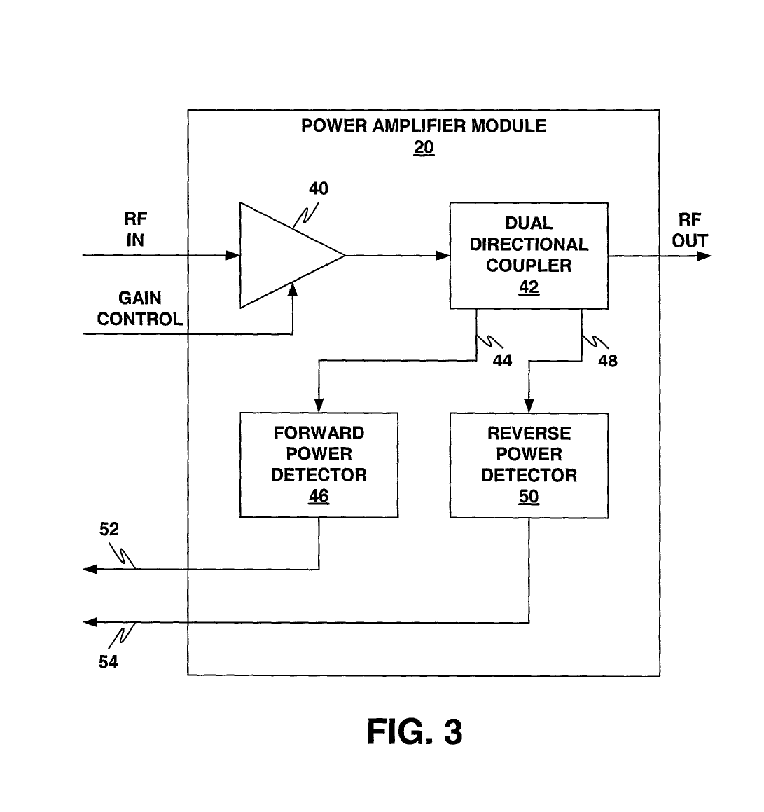

FIG. 3 is a block diagram illustrating an example implementation of power amplifier module 20. A power amplifier 40 amplifies a filtered signal from bandpass filter 24 of FIG. 2 according to a gain factor configured by microprocessor 28. The amplified signal is output to antenna 30 and duplexer 32 through a dual directional coupler 42. As noted above, some of the power output by power amplifier module 20 is reflected. Dual directional coupler 42 separates the signal present on the transmission line between power amplifier 40 and antenna 30 and duplexer 32 into a transmitted component and a reflected component. The transmitted component is provided via an output 44 to a forward power detector 46, which measures the power of the transmitted component. The reflected component is provided via an output 48 to a reverse power detector 50, which measures the power of the reflected component. Both the forward power detector 46 and the reverse power detector 50 may be implemented, for example, using conventional integrated broadband power detectors or other well known power detectors. The transmitted and reflected signal power levels are provided to microprocessor 28 as digital signals via outputs 52 and 54, respectively. In addition, one or both of the transmitted and reflected signal power levels may be output to other components of WCD 6.

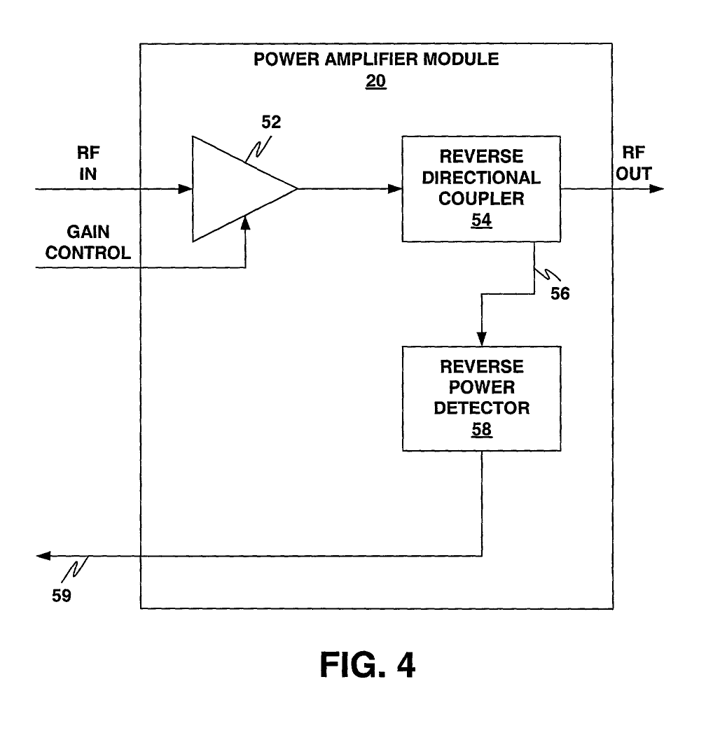

FIG. 4 is a block diagram illustrating another example implementation of power amplifier module 20. A power amplifier 52 amplifies a filtered signal from bandpass filter 24 of FIG. 2 according to a gain factor configured by microprocessor 28. The amplified signal is output to antenna 30 and duplexer 32 through a reverse directional coupler 54. As noted above, some of the power output by power amplifier module 20 is reflected. Reverse directional coupler 54 extracts a reflected component from the signal present on the transmission line between power amplifier 52 and antenna 30 and duplexer 32. The reflected component is provided via an output 56 to a reverse power detector 58, which measures the power of the reflected component. Reverse power detector 50 may be implemented, for example, using a conventional integrated broadband power detector or another well-known power detector. The reflected signal power level is provided to microprocessor 28 as a digital signal via an output 59. In addition, the reflected signal power level may be output to other components of WCD 6.

To facilitate accurate detection of the reflected signal power level, reverse power detector 50 may be calibrated at a variety of output power levels. For example, a detected reflected power of ⅓ W may result from a 2:1 VSWR mismatch when the output of power amplifier module 20 is 1 W. On the other hand, a detected reflected power of ⅓ W may also result from a 1.4:1 VSWR mismatch when the output of power amplifier module 20 is 2 W. Calibrating reverse power detector 50 facilitates distinguishing between these possibilities.

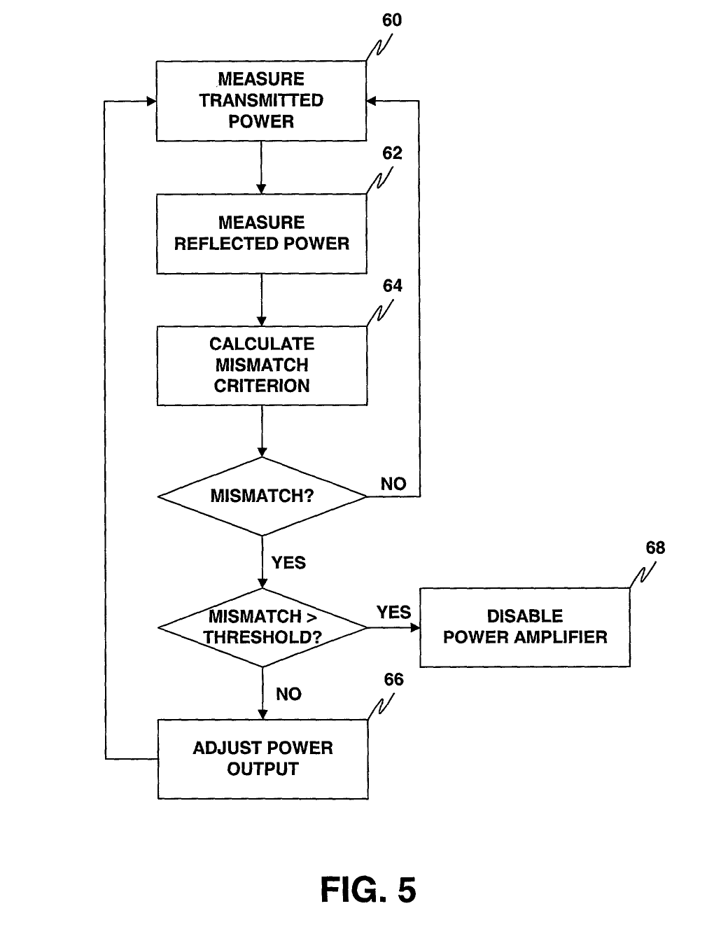

FIG. 5 is a flow diagram depicting an example mode of operation of WCD 6. Forward power detector 46 measures a transmitted signal power level (60), and reverse power detector 50 measures a reflected signal power level (62). Based on these power levels, microprocessor 28 calculates a mismatch criterion (64). The mismatch criterion can be calculated in a number of ways. For example, microprocessor 28 may calculate the ratio of the reflected signal power level to the transmitted signal power level. As an alternative, microprocessor 28 may calculate the ratio of the reflected signal power level to the total power level. The mismatch criterion can also be based on the transmitted signal power level.

As a particular example, if 1 W is output by power amplifier module 20 and reverse power detector 50 measures a reflected power signal level of 0.75 W, the mismatch criterion may be calculated as 0.75 W/1 W=0.75. Alternatively, with a transmitted power signal level of 0.25 W (1 W−0.75 W), the mismatch criterion may be calculated as 0.75 W/0.25 W=3. Both of these ratios indicate a mismatched load for which gain adjustment may be desirable. On the other hand, if only 10% of the power output is reflected back to power amplifier module 20, the gain of power amplifier module 20 may not need to be adjusted.

If a mismatch condition exists, e.g., if the ratio of the reflected signal power level to the transmitted signal power level exceeds a prescribed threshold, microprocessor 28 reduces the power output (66) of power amplifier module 20. Microprocessor 28 may reduce the power output, for example, by configuring the gain of power amplifier module 20. Signal distortion may thus be reduced to acceptable levels. If antenna 30 and duplexer 32 are sufficiently mismatched to power amplifier module 20, e.g., if the ratio of the reflected signal power level to the transmitted signal power level exceeds another threshold, microprocessor 28 may disable (68) power amplifier module 20.

Various signal distortion reduction techniques have been described as being implemented in hardware. Example hardware implementations may include implementations within a DSP, an application specific integrated circuit (ASIC), a field programmable gate array (FPGA), a programmable logic device, specifically designed hardware components, or any combination thereof.

In addition, various other modifications may be made without departing from the spirit and scope of the invention. Further, while several embodiments have been described in the context of a CDMA device, the principles described herein may be implemented in connection with any wireless communication device that employs a power amplifier. Accordingly, these and other embodiments are within the scope of the following claims.

1. A method comprising:
evaluating a load mismatch criterion relative to a wireless transmitter; and
configuring a power amplifier associated with the wireless transmitter as a function of the load mismatch criterion.

2. The method of claim 1, further comprising:
detecting a transmitted power signal and a reflected power signal; and
calculating the load mismatch criterion as a function of the transmitted and reflected power signals.

3. The method of claim 2, further comprising separating a power signal into the transmitted power signal and the reflected power signal.

4. The method of claim 1, wherein configuring the power amplifier comprises configuring a gain of the power amplifier.

5. A method comprising:
receiving at least one of a transmitted power signal level and a reflected power signal level from a power amplifier associated with a wireless transmitter; and
configuring a gain of the power amplifier as a function of the transmitted and reflected power signal levels.

6. The method of claim 5, further comprising detecting at least one of a transmitted power signal and a reflected power signal.

7. The method of claim 6, further comprising separating a power signal into the transmitted power signal and the reflected power signal.

8. A processor readable medium containing processor executable instructions for:
evaluating a load mismatch criterion relative to a wireless transmitter; and
configuring a power amplifier associated with the wireless transmitter as a function of the load mismatch criterion.

9. The processor readable medium of claim 8, containing further processor executable instructions for:
receiving a transmitted power signal level and a reflected power signal level; and
calculating the load mismatch criterion as a function of the transmitted and reflected power signals.

10. The processor readable medium of claim 8, containing further processor executable instructions for configuring a gain of the power amplifier.

11. A processor readable medium containing processor executable instructions for:
receiving at least one of a transmitted power signal level and a reflected power signal level from a power amplifier associated with a wireless transmitter; and
configuring a gain of the power amplifier as a function of the transmitted and reflected power signal levels.

12. A wireless communication device comprising:
a wireless transmitter;
a power amplifier to output a signal from the wireless transmitter; and
a controller to configure the power amplifier as a function of a load mismatch criterion determined from the signal.

13. The wireless communication device of claim 12, wherein the controller configures a gain of the power amplifier as a function of the load mismatch criterion.

14. The wireless communication device of claim 12, wherein the controller is configured to calculate the load mismatch criterion as a function of a transmitted power signal level and a reflected power signal level determined from the signal.

15. The wireless communication device of claim 12, further comprising a dual-directional coupler to separate the signal into a transmitted power signal component and a reflected power signal component.

16. The wireless communication device of claim 15, further comprising:
a first power detector coupled to receive the transmitted power signal component and configured to generate a transmitted power signal level; and
a second power detector coupled to receive the reflected power signal component and configured to generate a reflected power signal level.

17. The wireless communication device of claim 16, wherein at least one of the first and second power detectors comprises a broadband power detector.

18. The wireless communication device of claim 16, wherein the controller is configured to receive the transmitted and reflected power signal levels.

19. An integrated circuit comprising:
a power amplifier to output a signal from a wireless transmitter; and
a controller to configure the power amplifier as a function of a load mismatch criterion determined from the signal.

20. The integrated circuit of claim 19, wherein the controller configures a gain of the power amplifier as a function of the load mismatch criterion.

21. The integrated circuit of claim 19, wherein the controller is configured to calculate the load mismatch criterion as a function of a transmitted power signal level and a reflected power signal level determined from the signal.

22. The integrated circuit of claim 19, further comprising a dual-directional coupler to separate the signal into a transmitted power signal component and a reflected power signal component.

23. The integrated circuit of claim 22, further comprising:
a first power detector coupled to receive the transmitted power signal component and configured to generate a transmitted power signal level; and
a second power detector coupled to receive the reflected power signal component and configured to generate a reflected power signal level.

24. The integrated circuit of claim 23, wherein at least one of the first and second power detectors comprises a broadband power detector.

25. The integrated circuit of claim 23, wherein the controller is configured to receive the transmitted and reflected power signal levels.

26. An apparatus comprising:
a power amplifier;
a dual-directional coupler to separate a power signal into a transmitted power signal component and a reflected power signal component;
a first power detector to generate a transmitted power signal level;
a second power detector to generate a reflected power signal level; and
a control arrangement to configure the power amplifier as a function of the transmitted and reflected power signal levels.

27. An apparatus comprising:
a power amplifier;
a directional coupler to extract a reflected power signal component from a power signal;
a reverse power detector to generate a reflected power signal level; and a control arrangement to configure the power amplifier as a function of the reflected power signal level.

28. An apparatus comprising:
a wireless transmitter;
a power amplifier to output a signal from the wireless transmitter; and
a controller configured to
evaluate a load mismatch criterion relative to the wireless transmitter, and
configure the power amplifier as a function of the load mismatch criterion.

29. The apparatus of claim 28, wherein the controller is further configured to:
detect a transmitted power signal and a reflected power signal; and
calculate the load mismatch criterion as a function of the transmitted and reflected power signals.

30. An apparatus comprising:
means for evaluating a load mismatch criterion relative to a wireless transmitter; and
means for configuring a power amplifier associated with the wireless transmitter as a function of the load mismatch criterion.

31. The apparatus of claim 30, further comprising:
means for detecting a transmitted power signal emitted by an antenna associated with the wireless transmitter and a reflected power signal reflected by the antenna toward the power amplifier; and
means for calculating the load mismatch criterion as a function of the transmitted and reflected power signals.

32. The apparatus of claim 31, further comprising means for separating a power signal into the transmitted power signal and the reflected power signal.

33. The apparatus of claim 30, further comprising means for configuring a gain of the power amplifier.

34. An apparatus comprising:
means for receiving at least one of a transmitted power signal level and a reflected power signal level from a power amplifier associated with a wireless transmitter; and
means for configuring a gain of the power amplifier as a function of the transmitted and reflected power signal levels.

35. The apparatus of claim 34, further comprising means for detecting at least one of a transmitted power signal and a reflected power signal.

36. The apparatus of claim 35, further comprising means for separating a power signal into the transmitted power signal and the reflected power signal.
